(19) United States
(12) Patent Application Publication
(10) Pub. No.: US 2021/0131248 A1
(43) Pub. Date: May 6, 2021

(54) LOAD LEVELING POWER STORAGE SYSTEM FOR ELECTRIC HYDRAULIC FRACTURING

(71) Applicant: U.S. Well Services, LLC, Houston, TX (US)

(72) Inventors: Brandon Hinderliter, Houston, TX (US); Jared Oehring, Houston, TX (US); Steven Riley, Houston, TX (US)

(73) Assignee: U.S. Well Services, LLC, Houston, TX (US)

(21) Appl. No.: 17/087,068

(22) Filed: Nov. 2, 2020

Related U.S. Application Data
(60) Provisional application No. 62/930,184, filed on Nov. 4, 2019.

(51) Int. Cl. E21B 43/26; H02J 13/00; H02J 3/32; H02J 3/30; H02J 3/38

(52) U.S. Cl. CPC E21B 43/26; H02J 13/00036; H02J 3/381; H02J 3/30; H02J 3/32

(57) ABSTRACT

A fracturing system includes a generator having a specific set point, a power storage system, a microgrid, and one or more fracturing system components configured to receive power from the microgrid. In some embodiments, the power storage system includes a chargeable power storage device. The generator provides power to the microgrid via a first circuit breaker. The power storage system is electrically coupled to a second circuit breaker to controllably supply power to or receive power from the microgrid via the second circuit breaker. The power storage system charges when the first and second circuit breakers are both closed. The power storage system stops charging when the one or more fracturing system component requires power. The power storage system discharges power to the microgrid when a load requirement of the one or more fracturing system components is above the set point.

### CROSS-REFERENCE TO RELATED APPLICATIONS

This application claims priority to and the benefit of U.S. Provisional Application No. 62/930,184, filed Nov. 4, 2019, entitled “LOAD LEVELING POWER STORAGE SYSTEM FOR ELECTRIC HYDRAULIC FRACTURING”, the full disclosure of which is incorporated herein by reference for all purposes.

### FIELD OF INVENTION

This invention relates in general to hydraulic fracturing technology, and more particularly to systems and methods for power storage for electric hydraulic fracturing.

### BACKGROUND

Preserving the life and durability of power generators have become a top priority since introducing clean fleet. Overloading power generation equipment not only reduces its life span, but also create a hazardous environment on pad due to malfunctions and overheating in close proximity with the other fracking equipment. Fast response energy storage systems are a viable option with assisting power distribution during those times in particular. Not only are they a rapid and effective way to supply power when the demand is high, they also possess other features that help provide continuous reliable power to fracking equipment.

### SUMMARY OF THE INVENTION

In accordance with one or more embodiments, a fracturing system includes a generator having a specific set point, a power storage system, a microgrid, and one or more fracturing system components configured to receive power from the microgrid. In some embodiments, the power storage system includes a chargeable power storage device. The chargeable power storage device may be a solid state battery, a flow battery, a flywheel, or a capacitor. The microgrid includes a first circuit breaker. The generator provides power to the microgrid via the first circuit breaker. The microgrid further includes a second circuit breaker. The power storage system is electrically coupled to the second circuit breaker to controllably supply power to or receive power from the microgrid via the second circuit breaker. The first and second circuit breakers are connected to a common bus for load sharing. The power storage system charges when the first and second circuit breakers are both closed. The power storage system stops charging when the one or more fracturing system component requires power. The power storage system discharges power to the microgrid when a load requirement of the one or more fracturing system components is above the set point. The power storage device powers the one or more fracturing system component during conditions in which the generator is down. The generator charges the power storage device when the first and second circuit breakers are both closed. The power storage device disconnects from receiving power from the generator when the one or more fracturing system components draw power. The power storage device provides power to auxiliary devices and starters for one or more generators. In some embodiments, the fracturing system further includes one or more additional power storage systems coupled to the microgrid.

In accordance with another embodiment, a fracturing system includes a generator set at a specific set point and a power storage system comprising a chargeable power storage device, and configured to receive power from the generator. The chargeable power storage device may be a solid state battery, a flow battery, a flywheel, or a capacitor, among others. The fracturing system further includes a microgrid configured to receive power from the power storage system and one or more fracturing system components configured to receive power from the microgrid. The fracturing system also includes an incoming breaker coupled between the generator and the chargeable power storage device and an outgoing breaker between the chargeable power storage device and the microgrid. During conditions in which the one or more fracturing system components require a load below the set point, the power storage system is charged by the generator. During conditions in which the one or more fracturing system components require a load above the set point, the one or more fracturing system components are powered by both the generator and the power storage system. The power storage device powers the one or more fracturing system component during conditions in which the generator is down. The generator and the power storage system are electrically coupled in series. The power storage device disconnects from receiving power from the generator when the one or more fracturing system components draw power. The power storage device provides power to auxiliary devices and starters for one or more generators. In some embodiments, the fracturing system includes one or more additional power storage systems coupled to the microgrid.

In accordance to another embodiment, a method of powering a fracturing system includes supplying power to one or more components of the fracturing system from a generator, charging a power storage system from the generator during one or more conditions in which the load requirement of the one or more components of the fracturing system is below the set point of the generator, and supplying power to the one or more components of the fracturing system from both the generator and the power storage system during one or more conditions in which the load requirement of the one or more components of the fracturing system is above the set point of the generator. In some embodiments, the power storage system includes a chargeable power storage device. In some embodiments, the method further includes supplying power to the one or more components of the fracturing system from the power storage system during conditions in which the generator is down. The power storage device disconnects from receiving power from the generator when the one or more fracturing system components draw power. The power storage device provides power to auxiliary devices and starters for one or more generators. The generator and the power storage system may be electrically coupled in series or in parallel via a bus.

### BRIEF DESCRIPTION OF THE DRAWINGS

FIG. 1 illustrates a simplified diagram of an electronic system of a fracturing system, in accordance with various embodiments.

FIG. 2 illustrates a simplified diagram of another embodiment of an electronic system of a fracturing system, in accordance with various embodiments.

FIG. 3 illustrates a power supply charging and discharging scheme, in accordance with various embodiments.

FIG. 4 illustrates amount of power stored and released demand during a hydraulic fracturing operation, in accordance with various embodiments.

FIG. 5 is a flowchart illustrating a method of load leveling in a fracturing system, in accordance with various embodiments.

### DETAILED DESCRIPTION OF THE INVENTION

The foregoing aspects, features and advantages of the present technology will be further appreciated when considered with reference to the following description of preferred embodiments and accompanying drawings, wherein like reference numerals represent like elements. In describing the preferred embodiments of the technology illustrated in the appended drawings, specific terminology will be used for the sake of clarity. The present technology, however, is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

In various embodiments, like components may be referred to with the same reference numerals throughout the specification. However, in certain embodiments, different reference numerals may be used for clarity. Additionally, components of a similar nature may be referred to with a reference numeral and a letter, such as A and B, for clarity, and should not be construed as limiting. For example, while similar components may be referred to with reference numerals and an associated A and B, there components may have different sizes, shapes, or different operational mechanisms.

Load leveling is the process of flattening the electrical load so that it remains constant over a given time. In accordance with the techniques of the present disclosure, the charging of a power storage system can raise the load to the average load of the system when demand is low. When the demand rises, the energy stored in the power storage system is discharged so that the load profile can remain constant on the generating power source.

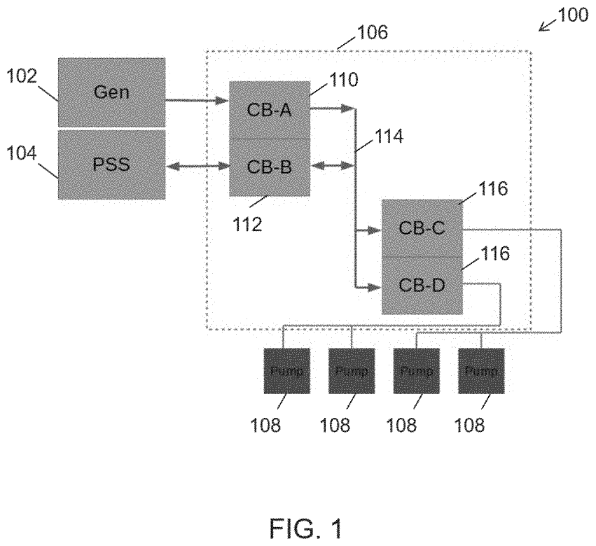

FIG. 1 illustrates a simplified diagram of an electronic system 100 of a fracturing system, in accordance with various embodiments. In accordance with one or more embodiments, the system 100 includes a power source such as a generator 102, a power storage system 104, a microgrid 106, and one or more fracturing system components 108 configured to receive power from the microgrid 106. In some embodiments, the power storage system 102 includes a chargeable power storage device. The chargeable power storage device may be a solid state battery, a flow battery, a flywheel, or a capacitor. Solid state batteries are often paired with a software system than can charge or discharge based on energy usage. Flow batteries are rechargeable batteries that store energy directly in an electrolyte solution and respond quickly as needed. Ideally, the PSS will be able to provide up to 4 MWh of power. Solid state batteries such as electrochemical capacitors, Lithium Ion, Nickel-Cadmium, and Sodium Sulfur can all aid in load leveling. Flow batteries which include redox, iron-chromium, vanadium redox, and zinc-bromine are all methods of storing energy. Flywheels are rotating mechanical device that is used to store rotational energy that can be called up instantaneously. Traditional capacitors may also be used release power onto the microgrid. They do not require the chemical reaction that batteries need in order to produce power, and are able to capture energy from intermittent energy sources over time and deliver a continuous supply of uninterrupted power.

The microgrid 106 may include a first circuit breaker (CB-A) 110 and a second circuit break (CB-B) 112. The generator 102 provides power to the microgrid 106 via the first circuit breaker 110. The generator 102 may be set a specific power output (i.e., set point) which is based on the microgrid load requirement as well as the capabilities of the generator 102. The generator 102 may be a turbine generator, among other types of generators. In some embodiments, the power storage system 104 is electrically coupled to the second circuit breaker 112 to controllably supply power to or receive power from the microgrid 106 via the second circuit breaker 112. Ground check technology could be implemented to verify continuity. If the ground check senses an open circuit, it will not allow the breaker to close. This is used to simply assure that there are no loose connections between the power storage system 104 and microgrid 106. This ground check wire can be embedded in a jacketed multi-conductor cable.

The first and second circuit breakers 110, 112, may be connected to a common bus 114 for load sharing, which may include a large copper bar used to share power evenly to downstream equipment based on power demand. The first and second circuit breakers may be in the same switchgear system, such as a trailer.

The power storage system 104 charges when the first and second circuit breakers 110, 112 are both closed and the generator 102 is energized. The power storage system 104 stops charging when the one or more fracturing system component 108 requires power. Specifically, in some embodiments, once power is required for the fracturing equipment 108, the power storage system 104 disconnects from the generator 102 so that the equipment load can take its place keeping the power output at the same point. The power storage system discharges power to the microgrid when a load requirement of the one or more fracturing system components is above the set point. If the fracturing equipment demands a higher load than the load set point, the power storage system 104 reconnects to the microgrid and discharges its power onto the microgrid to accommodate for the higher power demand. Once the load requirement falls back to the set point or below (which typically happens in between frac stages), the power storage system 104 replenishes stored energy used previously until it is either fully charged or needed to discharge its power to supplement the generator 102 again. The power storage system 104 powers the one or more fracturing system component 108 during conditions in which the generator 102 is down. The generator 102 charges the power storage system 104 when the first and second circuit breakers 110, 112 are both closed. The power storage system 104 disconnects from receiving power from the generator 102 when the one or more fracturing system components 108 draw power. The power storage system 104 can also provide power to auxiliary devices and starters for one or more generators. In some embodiments, the system 100 may include one or more additional power storage systems 104 coupled to the microgrid.

The system may further include one or more feeder breakers 116 that are used to selectively energize the one or more fracturing equipment components 108. For example, in an embodiment, the system may include 24 feeder breakers 116 that are used respectively to control power for 24 individual equipment components such as frac pumps, blenders, chemical additive units, cranes, wireline trailers, water pumps, among others. These feeder breakers 116 may also be used to protect interconnecting cables between the switchgear trailers and frac equipment while giving operators a place to “lockout” the equipment to allow safe removal of trailers without shutting down the primary generator or disconnecting power to all of the connected frac equipment.

In some embodiments, power from the power storage system 104 can be delivered in multiple single conductor cables or in multiphase jacketed cables. Single conductor cables can be terminated with standard 2-hole lugs with stress cones to be directly bolted to bus work or can be terminated with engineered male and female couplers that can quickly locked into place. The engineered couplers may have ground check wires embedded to make sure a proper connection is made. These couplers can be twist-lock style or can be compressed together using multiple jam nuts. Multi-conductor, 3 phase, cables need to be terminated in an engineered male/female coupler mechanism. These can be designed similarly to the couplers for the single conductor cables but require additional shielding, are far larger, and have a ground conductor embedded along with the ground check conductor. The system may be used for common voltage rated systems which include 25 KV, 15 KV, 13.8 KV, 4160V, 720V, 600V, and 480V.

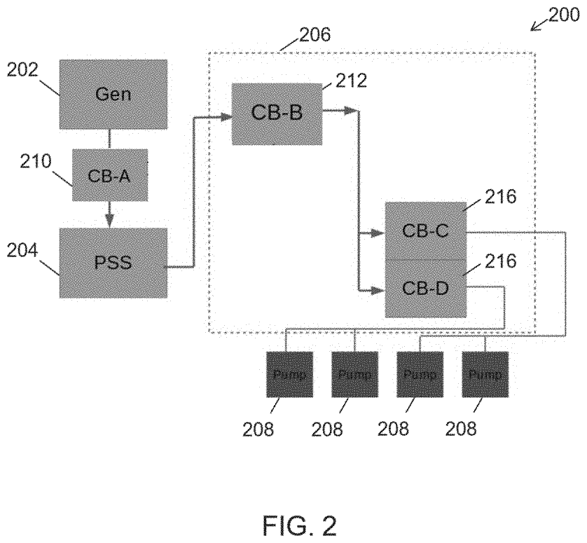

FIG. 2 illustrates a simplified diagram of another embodiment of an electronic system 200 of a fracturing system in which the generator 202 and the power storage system 204 are configured in series, in accordance with various embodiments. The system 200 includes a power source such as a generator 202 and a power storage system 204 having a chargeable power storage device. The chargeable power storage device may be a solid state battery, a flow battery, a flywheel, or a capacitor, among others. The power storage system 204 is configured to receive power from the generator 202. The fracturing system further includes a microgrid 206 configured to receive power from the power storage system 204 and one or more fracturing system components 208 configured to receive power from the microgrid 206. The system 200 also includes an incoming breaker 210 coupled between the generator 202 and the chargeable power storage device of the power storage system 204 and an outgoing breaker 212 between the chargeable power storage device and the microgrid. In some embodiments, a plurality of generators 202 may be utilized in this manner. The generator 202 is plugged into the power storage system 204 where an internal bus electrically connects the battery banks (i.e. chargeable power storage device) to the incoming breaker 210 from the generator 202 and the outgoing breaker 212 for the power distribution microgrid 206.

Under normal operations (i.e., the load requirement is below the capability of the generator), the generator 202 charges the power storage system 204, while also powering the downstream equipment components 208. If the power demand becomes too high (e.g., higher than the capability of the generator), the power storage system 204 discharges onto the internal bus/microgrid 206 to help power the load. If the generator 202 shuts down the power storage system 204 will power the load until the stored power is completely discharged or the generator is brought back online.

In some embodiments, the power storage system 204 disconnects from receiving power from the generator 202 when the one or more fracturing system components 208 draw power. Upon reaching full capacity, the power storage system 204 can disconnect from the power source 202 allowing power to bypass the power storage system 204 straight to the microgrid/switchgear 206. The power storage system 204 can also provide power to auxiliary devices and starters for one or more generators. In some embodiments, the power storage system 204 could also be charged by a utility grid in the event a power generation device is not available. There could also be additional circuit breakers for multiple generators or utility grid connections. The system may further include one or more feeder breakers 216 that are used to selectively energize the one or more fracturing equipment components 208.

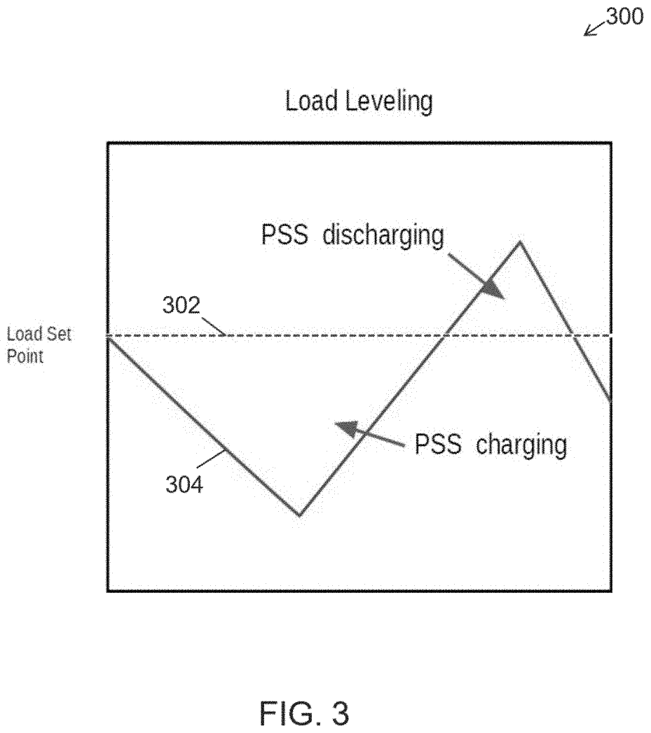

FIG. 3 is a graph 300 illustrating a charging and discharging scheme of such a power storage system, in accordance with various embodiments. Dotted line 302 represents the set point of the generator 102 (FIG. 1) and the solid line 304 represents the power demand or load of the connected fracturing equipment. If the load requirement 304 is below the set point 302, there is excess power capacity in the generator 102 and the power storage system 104 can charge. If the load requirement 304 is greater than the set point 302, then the power storage system 104 can discharge to the power consuming equipment 108 to make up the difference between the generator capability and the power requirement.

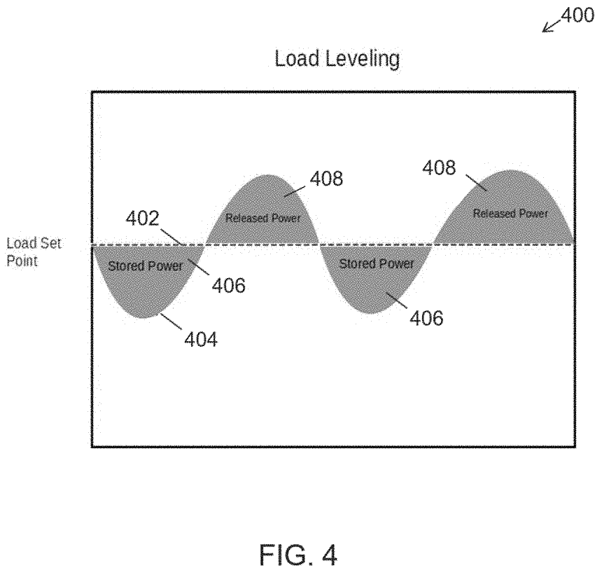

FIG. 4 is a graph 400 illustrating the amount of power stored 406 and power released 408 by the power storage system 104 (FIG. 1) as a function of load requirement 404 during a hydraulic fracturing operation, in accordance with various embodiments. Dotted line 402 represents the set point of the generator 102 and the solid line 404 represents the power demand or load of the connected fracturing equipment 108. As illustrated in portions 406, the lower the load requirement is from the set point 402, the more power from the generator 102 is used to charge the power storage system 104 and thus more power is stored to the power storage system 104. As illustrated in portions 408, the higher the load requirement is from the set point 402, the more power is released from the power storage system 104 to help power the fracturing equipment 108.

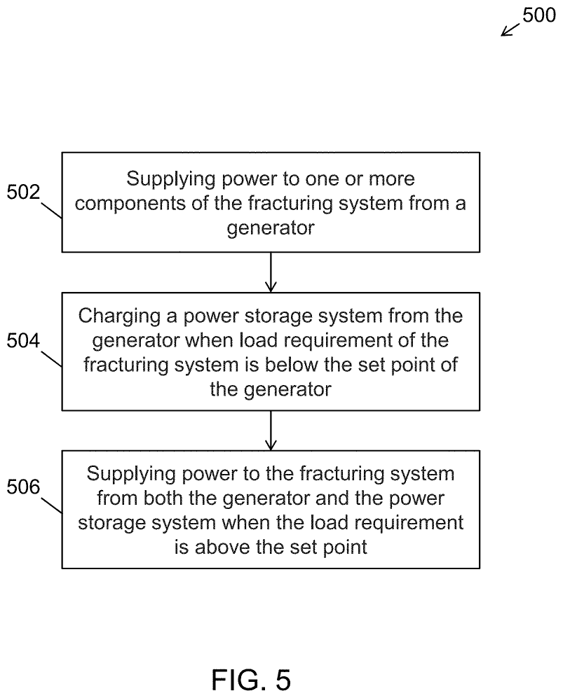

FIG. 5 is a flowchart illustrating a method 500 of load leveling in a fracturing system, in accordance with various embodiments. The steps of method 500 can be performed in any order, and in any iteration, and with additional or fewer steps. The method 500 includes supplying (502) power to one or more components of the fracturing system from a generator, charging (504) a power storage system from the generator during one or more conditions in which the load requirement of the one or more components of the fracturing system is below the set point of the generator, and supplying (506) power to the one or more components of the fracturing system from both the generator and the power storage system during one or more conditions in which the load requirement of the one or more components of the fracturing system is above the set point of the generator. In some embodiments, the power storage system includes a chargeable power storage device. In some embodiments, the method further includes supplying power to the one or more components of the fracturing system from the power storage system during conditions in which the generator is down. The power storage device disconnects from receiving power from the generator when the one or more fracturing system components draw power. The power storage device provides power to auxiliary devices and starters for one or more generators. The generator and the power storage system may be electrically coupled in series or in parallel via a bus.

Electric equipment such as vacuum breakers and interconnecting power cables can be used to connect the power storage system to the microgrid. Power from the power storage system can be delivered as multiphase power via copper or aluminum conductors. The system can be instrumented such that the system can be controlled and monitored from the data van via fiber optic connection.

Cooling of the system can be performed with industrial air conditioning units. This may take the form of multiple smaller units placed along the roof of the enclosure and/or on each end. Liquid cooling could also be used which would require a coolant pump for coolant circulation, a coolant reservoir, as well as a radiator and radiator fan. The coolant could be pumped through the battery compartments to maintain a desired temperature. Cooling equipment can be powered directly from the internal battery bus or from a shore power connection such as an external generator. The advantages of this are so the batteries can be climate controlled even if the internal batteries are completely discharged. This could occur if the primary generator failed and the PSS was used to power the frac equipment, or if the power storage system was discharged for mobilization or long term storage. Heating may be needed during cold months or prior to energization. For example, industrial A/C units could be utilized. Alternatively, small space heaters in each battery compartment could be used to provide heat. These could operate on a lower voltage such as 120/240 VAC or even DC power such as 12V, 24V, or 48V. A small step down transformer can be used to provide the power which can be drawn directly from the internal battery bus or from a shore power connection such as an external generator.

In some embodiments, a single power storage system 304 can provide as much as 4 MW power output and up to 4 MW-hours. Smaller units could be built to save costs or physical sizes such as a unit that is designed to output 2 MW with 2 MW-hours of power storage. Multiple PSS units could be electrically connected to a switchgear trailer that acts as a common bus to distribute power to fracturing equipment or to charge the power storage system 304 from a generator 302 or utility grid.

As an alternative to wired communications from data van to the power storage system, satellite communications or WiFi could also be used. Communications can also be used between the power storage system and the primary generators and microgrid (i.e., switch gear systems). The power storage system trailers can be electrically connected to the microgrid by a cable connection to a switch gear trailer or by connecting it directly to a frac pump or blender trailer. This system can also be trailer mounted or skid mounted.

The power storage system can replace supplemental generators (e.g., gas turbine generators), which has many advantages. The fracturing system would require fewer gas connections on site. Only the primary generator that charges the power storage system would need a fuel source. Therefore, gas connections can be contained to one area of the well site with fewer gas connections that could leak, fewer gas hoses that need inspected and tested regularly, and smaller exclusion zones. The fracturing system would also require fewer cable connections. Most turbine generators are composed of at least two separate trailers that need power connections spanning in between them. These power connections could be for auxiliary systems such as heating, controls, and sensors or for power output from the generator to a switch gear system. For example, one of our turbine packages has as many as interconnecting 60 cables and 6 outgoing power cables. A power storage system may have as few as a single outgoing 3 phase power cable and 1 or 2 optional communication cables.

The fracturing system would also require fewer high temperature components. Turbine engines have sections that reach temperatures exceeding 1250° F. These sections are severe hazards to personnel and equipment. The exhaust gases also exceed 900° F. and need to be expelled in a safe direction. The fracturing system would also require fewer high RPM components. Most diesel equipment rarely have any drive mechanisms that exceed 1000 RPM. However, turbine engines have internal blades and shafts that exceed the 10,000 RPM range.

The power storage system has been benefits and advantages, including the following:

Load Leveling: The power storage system has the ability to store energy in times of low demand only to be released in times of high power demand. For example, the power storage system would charge during fracking stages that require lower and discharge power during the stages with higher load requirements. This helps to increase the lifespan of the power generating asset by allowing it to not work as hard.

Frequency Regulation: The power storage system can charge and discharge in response to an increase or decrease of microgrid frequency and can keep it within a preset limit. This increases grid stability. Essentially, the energy storage system can ramp up or down the generating asset in order to synchronize the generator with microgrid operation.

Power Quality Control: The power storage system may protect downstream loads such as sensitive electronic equipment and microprocessor-based controls against short-duration disturbances in the microgrid, which may affect their operation.

Emergency Power: In the event of a generator failure (for example, due to a mechanical fault, electric fault, or due to a fuel supply loss), the power storage system can provide sufficient electric power to flush the wellbore. This can prevent a “screen out” where the loss of fluid velocity causes the proppant in the frac slurry to drop out and settle in the wellbore, which can plug off the perforations and cause several days of downtime to clear. The power storage system can allow an electric frac fleet to properly flush the well by being able to power the electric blender as well as sufficient frac pumps to displace the proppant laden slurry completely into the formation without generator power.

Black Start Power: The power storage system can also be used for black start power. Conventionally, a small generator is used to provide power to ancillary systems such as heaters, blowers, sensors, lighting, PLCs, electric over hydraulic systems, and electric over air systems for the larger generators, as well as provide power the starters for larger generators. These starters may be electric starters with a VFD or soft starter, or can be hydraulic starters with electric motors powering the hydraulic pumps. If the power storage system is properly charged, it can replace the black start generator to allow the larger generators (usually turbines) to start from a black out condition.

Load Bank: The power storage system can be used as a load bank to test and verify generator performance during commissioning or after mobilization. It can also work for load rejections, to dissipate power during sudden shut downs such as if a wellhead exceeds the maximum pressure and every frac pump is shut down simultaneously without warning.

Reduced Maintenance: The power storage system is comprised of a solid state battery bank, which may have very few moving parts that will require far less maintenance than a generator utilizing a turbine or reciprocating engine.

Simplified Fuel Supply: The power storage system does not require a fuel supply as it is energized by the microgrid. Therefore, any fuel connections for liquid or gas fuel that would be required by secondary generators can be removed. This reduces connections and manifolds as well as fuel volumes required during peak demand.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A fracturing system, comprising:
a generator having a specific set point;
a power storage system comprising a chargeable power storage device;
a microgrid comprising:
a first circuit breaker, wherein the generator provides power to the microgrid via the first circuit breaker; and
a second circuit breaker, wherein the power storage system is electrically coupled to the second circuit breaker to controllably supply power to or receive power from the microgrid via the second circuit breaker, wherein the first and second circuit breakers are connected to a common bus for load sharing; and
one or more fracturing system components configured to receive power from the microgrid,
wherein the power storage system charges when the first and second circuit breakers are both closed, and the power storage system stops charging when the one or more fracturing system component requires power, and the power storage system discharges power to the microgrid when a load requirement of the one or more fracturing system components is above the set point.

2. The fracturing system of claim 1, wherein the chargeable power storage device is a solid state battery, a flow battery, a flywheel, or a capacitor.

3. The fracturing system of claim 1, wherein the power storage device powers the one or more fracturing system component during conditions in which the generator is down.

4. The fracturing system of claim 1, wherein the generator charges the power storage device when the first and second circuit breakers are both closed.

5. The fracturing system of claim 1, wherein the power storage device disconnects from receiving power from the generator when the one or more fracturing system components draw power.

6. The fracturing system of claim 1, wherein the power storage device provides power to auxiliary devices and starters for one or more generators.

7. The fracturing system of claim 1, further comprising:
one or more additional power storage systems coupled to the microgrid.

8. A fracturing system, comprising:
a generator set at a specific set point;
a power storage system comprising a chargeable power storage device, wherein the power storage system receives power from the generator;
a microgrid configured to receive power from the power storage system;
one or more fracturing system components configured to receive power from the microgrid;
an incoming breaker coupled between the generator and the chargeable power storage device; and
an outgoing breaker between the chargeable power storage device and the microgrid,
wherein during conditions in which the one or more fracturing system components require a load below the set point, the power storage system is charged by the generator; and
wherein during conditions in which the one or more fracturing system components require a load above the set point, the one or more fracturing system components are powered by both the generator and the power storage system.

9. The fracturing system of claim 8, wherein the chargeable power storage device is a solid state battery, a flow battery, a flywheel, or a capacitor.

10. The fracturing system of claim 8, wherein the power storage device powers the one or more fracturing system component during conditions in which the generator is down.

11. The fracturing system of claim 8, wherein the generator and the power storage system are electrically coupled in series.

12. The fracturing system of claim 8, wherein the power storage device disconnects from receiving power from the generator when the one or more fracturing system components draw power.

13. The fracturing system of claim 8, wherein the power storage device provides power to auxiliary devices and starters for one or more generators.

14. The fracturing system of claim 8, further comprising:
one or more additional power storage systems coupled to the microgrid.

15. A method of powering a fracturing system, comprising:
supplying power to one or more components of the fracturing system from a generator;
charging a power storage system from the generator during one or more conditions in which the load requirement of the one or more components of the fracturing system is below the set point of the generator; and
supplying power to the one or more components of the fracturing system from both the generator and the power storage system during one or more conditions in which the load requirement of the one or more components of the fracturing system is above the set point of the generator.

16. The method of claim 15, wherein the power storage system includes a chargeable power storage device.

17. The method of claim 15, further comprising:
supplying power to the one or more components of the fracturing system from the power storage system during conditions in which the generator is down.

18. The method of claim 15, wherein the power storage device disconnects from receiving power from the generator when the one or more fracturing system components draw power.

19. The method of claim 15, wherein the power storage device provides power to auxiliary devices and starters for one or more generators.

20. The method of claim 15, wherein the generator and the power storage system are electrically coupled in series.
